(19) United States
(12) Patent Application Publication
(10) Pub. No.: US 2026/0178558 A1
(43) Pub. Date: Jun. 25, 2026

(54) METHODS AND SYSTEMS FOR PROCESSING TABULAR DATA

(71) Applicant: Regrello Corp., San Francisco, CA (US)

(72) Inventors: Aman Naimat, San Francisco, CA (US); Seth A. Myers, Healdsburg, CA (US); William B. Buchanan, New York, NY (US)

(21) Appl. No.: 19/543,469

(22) Filed: Feb. 18, 2026

Related U.S. Application Data
(63) Continuation of application No. PCT/US2024/042788, filed on Aug. 16, 2024.
(60) Provisional application No. 63/520,504, filed on Aug. 18, 2023.

(51) Int. Cl. G06F 16/22

(52) U.S. Cl. CPC G06F 16/2282

(57) ABSTRACT

A method may obtain a plurality of tables of data, wherein the plurality of tables includes a plurality of cells arranged in rows and columns. A method may generate an output value for a cell of a first table with a transformer-based model, wherein the model includes a three-dimensional attention mechanism. A method may determine a first attention score across cells of the first table in the same row of the cell. A method may determine a second attention score across cells of the first table in the same column of the cell. A method may determine a third attention score across all rows of the first table. A method may determine a fourth attention score across embeddings from different tables of the plurality of tables. A method may calculate an embedding based on a combination of the attention scores. A method may determine the output value based on the embedding.

### CLAIM TO PRIORITY

This application claims benefit of and is a continuation of International Patent Application No. PCT/US2024/042788 (Attorney Docket No. 2134.0006), filed Aug. 16, 2024, and entitled “METHODS AND SYSTEMS FOR PROCESSING TABULAR DATA,” International Pub. No. WO 2025/042777, which is hereby incorporated by reference in its entirety for all purposes.

International Patent Application No. PCT/US2024/042788 relates to, incorporates by reference for all purposes, and claims priority to U.S. Provisional Application No. 63/520,504 (Attorney Docket No. 2134.0003), filed Aug. 18, 2023.

### SUMMARY

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

In some aspects, the techniques described herein relate to methods and systems for processing tabular data, the method including: obtaining a plurality of tables of data, wherein the plurality of tables includes a plurality of cells arranged in rows and columns; and generating an output value for a cell of a first table with a transformer-based model, wherein the model includes a three-dimensional attention mechanism and wherein the model generates the output value by: determining a first attention score across cells of the first table in the same row of the cell; determining a second attention score across cells of the first table in the same column of the cell; determining a third attention score across all rows of the first table; determining a fourth attention score across embeddings from different tables of the plurality of tables; calculating an embedding based on a combination of the attention scores; and determining the output value based on the embedding.

In some aspects, the techniques described herein relate to methods and systems, wherein the transformer-based model is a deep learning model.

In some aspects, the techniques described herein relate to methods and systems, wherein the output value includes a data validation for the cell.

In some aspects, the techniques described herein relate to methods and systems, wherein the output value includes a missing value for the cell.

In some aspects, the techniques described herein relate to methods and systems, wherein the model is fine-tuned on a set of tabular business data.

In some aspects, the techniques described herein relate to methods and systems, wherein the set is a very large set.

In some aspects, the techniques described herein relate to methods and systems, wherein the attention scores are computed on different layers of the model.

In some aspects, the techniques described herein relate to methods and systems, wherein the model is at least one of a fine-tuned model or a pre-trained model.

In some aspects, the techniques described herein relate to methods and systems, wherein the model is trained with masked cells.

In some aspects, the techniques described herein relate to methods and systems, wherein the masked cells are randomly selected.

In some aspects, the techniques described herein relate to one or more non-transitory, computer-readable media including computer-executable instructions that, when executed, cause at least one processor to perform actions including: obtaining a plurality of tables of data, wherein the plurality of tables includes a plurality of cells arranged in rows and columns; and generating an output value for a cell of a first table with a transformer-based model, wherein the model includes a three-dimensional attention mechanism and wherein the model generates the output value by: determining a first attention score across cells of the first table in the same row of the cell; determining a second attention score across cells of the first table in the same column of the cell; determining a third attention score across all rows of the first table; determining a fourth attention score across embeddings from different tables of the plurality of tables; calculating an embedding based on a combination of the attention scores; and determining the output value based on the embedding.

In some aspects, the techniques described herein relate to one or more non-transitory, computer-readable media, wherein the transformer-based model is a deep learning model.

In some aspects, the techniques described herein relate to one or more non-transitory, computer-readable media, wherein the output value includes a data validation for the cell.

In some aspects, the techniques described herein relate to one or more non-transitory, computer-readable media, wherein the output value includes a missing value for the cell.

In some aspects, the techniques described herein relate to one or more non-transitory, computer-readable media, wherein the model is fine-tuned on a set of tabular business data.

In some aspects, the techniques described herein relate to one or more non-transitory, computer-readable media, wherein the set is a very large set.

In some aspects, the techniques described herein relate to one or more non-transitory, computer-readable media, wherein the attention scores are computed on different layers of the model.

In some aspects, the techniques described herein relate to one or more non-transitory, computer-readable media, wherein the model is at least one of a fine-tuned model or a pre-trained model.

In some aspects, the techniques described herein relate to one or more non-transitory, computer-readable media, wherein the model is trained with masked cells.

In some aspects, the techniques described herein relate to one or more non-transitory, computer-readable media, wherein the masked cells are randomly selected.

### BRIEF DESCRIPTION OF THE FIGURES

The disclosure and the following detailed description of certain embodiments thereof may be understood by reference to the following figures:

FIG. 1 depicts aspects of an example of a layer of transformer-based model with parallel transformer functionality.

FIG. 2 depicts aspects of an example transformer-based model with transformers arranged in series.

FIG. 3 depicts aspects of an example of a layer of large table model.

FIG. 4 depicts aspects of an example of a layer of a large table model.

FIG. 5 depicts aspects of an example method for processing tabular data with a large table model.

FIG. 6 depicts aspects of another example method for processing tabular data with a large table model.

### DETAILED DESCRIPTION

Processing tabular data with AI models is challenging due to the complex structure, variability, and nature of the data. In one example, tabular data may include a mix of numerical, categorical, text, date, and possibly other data types. Each type of data may require different handling and processing considerations. In another example, table data may include variable length data where the number of rows and columns can vary significantly, making it hard to design a one-size-fits-all model. In another example, table data may include complex inter-row and inter-column relationships where different rows and columns interact or relate to each other. Tables may exhibit trends and relationships between rows and columns and/or rows and may require considerations of the multiple columns/rows and not just individual columns/rows in isolation.

Traditional models trained on one type of tabular data may not generalize well to other types of tabular data, requiring extensive retraining and adaptation. Likewise, the context in which the table data is used can vary widely, making it hard for a single traditional model to perform well across different scenarios.

Traditional large language models (LLMs) cannot adequately process tabular data. LLMs have no concept of structured data. Cells in the rows of a relational database table, for example, are treated as just another sequence of tokens without regard for the semantic meaning of the columns. LLMs are less effective in encoding and drawing inferences from structured data, which is required for tasks such as auto-completing data fields or providing a semantic understanding of structured data in general.

Embodiments described herein include a new class of models that solve the aforementioned problems. The new models include a new class of transformer that encodes relational data tables by understanding the semantic relationship between each row and column. Embodiments described herein provide for a foundation model for all structured information related to and provided by users. Some of the features and use-cases that this model could address include:
Auto-completing/predicting the value of form fields.
Flagging spurious data.
Supporting traditional LLMs as a reference/knowledge store.
Validating and modifying the user-facing output of LLMs such that it better reconciles with rows already found in trusted relational data tables. This could potentially be quite effective in mitigating the hallucination problem.
Natural text parsing of user communications—for example, parsing a natural text email a user receives from a vendor and then automatically generating or updating data objects.

Tabular data, as utilized herein, should be understood broadly, and may include structured data which may be organized into rows and columns, forming a table. Common examples of tabular data formats include spreadsheets, CSV (Comma-Separated Values) files, and SQL database tables. Tabular data is not limited to two dimensions and can extend to higher dimensions. Data values in tabular data are often contained in cells. In higher dimensions, cells can exist within multi-dimensional arrays, holding more complex data structures.

An example embodiment is a knowledge base that is generated and stored via a model such as a neural network. The knowledge base may include structured facts pertaining to tabular data. In the knowledge base, the semantics of heterogeneous structured data may be learned, linked, and understood, taking advantage of the structure of data and/or the data itself via one or more models such as a neural network. The neural network may be trained on structured data that is often expressed in tables, relational databases, spreadsheets, and other such structured information herein referred to as tabular data or table data. The knowledge base can then be applied to perform certain functions such as prediction, regression, data validation, data integration, data deduplication, etc., over new structured data found in tables or spreadsheets.

The methods and systems described herein are different from pre-trained deep learning models. Previous deep learning models are built over natural language text and do not capture the semantics of structured data (such as column and row semantics of tabular data) due to their inherent design focused on language. The model may include a Large Table Model (LTM). An LTM is different from a Large Language Model (LLM). The LTM, which may include one or more neural networks, captures, and/or understands data relationships between columns, between rows, between rows and columns, and across tables. Using these data relationships, LTMs can be used to predict a cell or missing value in the cell or validate if the value of the cell is correct. This is different from understanding the meaning of data using the transformer architecture popularized by Large Language Models like Bert, ChatGPT, etc., since LTMs do not focus on dependencies between words in a grammatical natural language but instead in a row and/or columns in a table.

Transformer-based large language models may not be appropriate and may not perform adequately on tabular data for a variety of reasons, such as:

LLMs that use transformers and their derivatives have positional dependencies. LLMs understand words in sequence (such as right to left and left to right or both) and utilize the position of the words in the sequence. Tables do not have the same positional dependencies as natural language. Tables may retain the same semantics with any order of columns. Tables contain raw data where the next word is not predictive of the words before because the data may be unordered.

Transformer-based models (i.e., Bert or ChatGPT) are trained to predict the next word and/or sentence, whereas rows in a table have no positional value. Each row is independent of the other and has no positional value. The positional encoding in transformers, therefore, may not directly apply to tabular data.

Transformers in language models (i.e., Bert or ChatGPT) ignore the semantics found in tables where each value in a column across rows has the same semantics. In many cases, each row in a table relates to the same concept and has similar semantics.

Transformers and the derivative LLM models utilize a lot of algorithms, resources, and power to understand unstructured data and do not apply directly to structured data such as tabular data and/or relational databases. These models miss the core of the semantics utilized in structured tables.

Transformers and the derivative LLM models do not honor (i.e., process or represent) column/cell boundaries. Transformers and their derivative LLM models treat the words in the next column and the words in the previous column with no different or special meaning. They create the dependencies like in natural language but do not realize that a word in the previous or next column is different from the words in the current column leading to semantic confusion and eventual inability to perform correct predictions over tabular data.

Transformers and the derivative LLM models miss the value of the structure of tabular data, which includes boundaries of columns, columns having the same data type and semantics, relationships between tables (joins), etc.

Transformers and the derivative LLM models trained over natural language are overly biased following overtraining on text like Wikipedia, news, and/or other text from websites and the internet. The models may overbias some elements with extra meaning.

An LTM may differ from an LLM in many important ways, including:

Training data: An LTM may be trained on structured data versus an LLM is trained on unstructured natural text. An LTM is trained on a large amount of heterogeneous structured data and can also be fine-tuned with the customer's structured data.

Training Algorithm: An LTM may utilize the masked language modeling paradigm and multi-head attention mechanisms. LTM includes new variations of attention mechanisms. In one example, the LTM may use a 3-dimensional attention mechanism. A 3-dimensional attention mechanism may be configured such that attention pays attention to the values in the row itself, all the columns in the row, and all the rows and creates the embedding for each cell that encompasses information about the columns and all rows, and thus the entire table itself.

Usage: The main usage of this model is not to generate text or the next word or the next sentence(s) as is the case for LLMs. Some usage examples for an LTM are listed herein. In one example, the LTM may be used to generate or predict the missing value(s) in a row of a table.

Benefits: LTMs may be used to improve data quality, reduce code for data validation, improve user experience in data entry forms, data integration, and generate structured search results.

Embodiments of the systems and methods described herein include a deep learning model for structured data that can learn from many disparate tabular sources. The model learns or may be trained on an embedding for each cell in the table by utilizing a 3-dimensional attention mechanism. The 3-dimensional attention mechanism includes a focus on attributes at the row level, the relationships between values in the same column, and/or the relationships between values in the rows in the table. This allows each cell to deeply understand the structure and context of the table it exists in (i.e., the encoding or embedding of each cell captures the context of the position and relation of the cell in the table) which can be used for various tasks such as, for example, to predict an empty cell in the table.

Aspects of one embodiment of the model and associated algorithms are described below.

Large amounts of structured data (in tables, spreadsheets, and/or json) may be fed into a deep neural feed-forward network. In some implementations, tens to hundreds of millions of tables may be used. Tables may include business data found in public, government, and private sources. Some examples of such tables are companies, products, parts, bill of material, orders, shipments, company financials, diseases, molecules, logistic data, economic indicators, duties, materials, chemicals, prices, economic indicators, business locations, product attributes, business relationships, addresses, stock performance over time, people, management, labor statistics, weather data, and the like.

In embodiments, training may include training to predict masked data in a table (i.e., masked cells in a table). In embodiments, masked data may be cells randomly picked and may include 10% of all cells in the table. In some implementations, more than 10% or fewer than 10% of the cells may be masked.

In embodiments, the deep learning model may include multiple layers which feed into each other. The first layer may be configured to learn the relationship between the rows by having each row pay attention to all the other rows in its table. The attention mechanism may include Query, Key, and Value elements that may be used to calculate an attention score. In embodiments, multiple heads may be utilized to learn different types of relationships. The number of heads may be derived through experimentation.

In embodiments, the first layer may feed into a second layer. The focus of the second layer may be to learn the semantics of the column and the relationships between a cell and all the other cells in the same column. The second layer may include a transformer/attention that may be configured to learn how the meaning of a cell is similar to the other cells in the same column. For example, a table may relate to an order and may include a cell with an order total. In the case of an order total, the model will learn the meaning of what it means to be an order total, the fact that it's a currency amount, and/or that a valid order total is a range of numbers between (i.e., a range such as between $159 and $5500 for one application). The model learns deeper information than a standard data type or name of the column. From this base information, it may also learn the underlying function that calculates the order total in the deeper layers.

In embodiments, the model may include a third layer. The third layer may be configured to learn the relationship between the attribute values of the row itself so each cell pays attention to other cells in the same row and learns what attribute values/cells it needs to pay attention to. By paying attention to other cell values in the same row it may learn additional context for each cell, for example, the model may learn that an order total is an order total for a specific product, for a given customer, which has the color white, and the currency is USD.

In embodiments, the embedding for each cell may be calculated by utilizing information from all the 3-dimensions so that the embedding captures and/or reflects the context of the entire table and how it relates to this cell.

In embodiments, one or more of the layers (such as the first layer, second layer, and/or the third layer described above) may feed into a transformer-like architecture with encoders where the deeper layers learn the more complex relationships between the columns, rows, and each cell and also between tables; thus, learning how to join between tables.

In embodiments, the model may be trained on heterogeneous training data (for example, training data may include data such as orders, part lists, material tables, and the like). The embedding for a value of “159” may capture or reflect that the value is most often associated with an iPhone product and may associate the value with names of materials or parts (i.e., the embedding of the value 159 may be in close proximity to embeddings of materials associated with the iPhone). The embedding has a deep understanding of a cell's (or the value of the cell) context in this knowledge base.

In one example, the context information captured in the embedding may be used to automatically complete table entries. In one scenario, when a new table in some other context is added and a user types “Apple” in a manufacturer cell and “$159” in the price cell, the trained model may be used to automatically generate the values in the remaining columns with the product name, weight, color, year produced, manufacturing location, common issues, etc. which could be columns from many disparate and lightly related sources.

The model may be implemented in various ways where it can create an embedding of a cell and have the ability to predict a new cell utilizing the above-mentioned 3-dimensions.

In one example, implementations may include training a deep learning transformer utilizing multiple heads for a given cell where some number of attention heads focus on the other attribute values/cells in the same row, some number of heads focus on the column, and some number of heads focus on paying attention to other rows in the same table. An embedding may be created for a cell using the standard vector concatenation function and learning the weights by predicting some percent of empty cells in the table.

In another example, implementations may include training three transformers separately where one pays attention between the attribute values/cells, a second transformer pays attention to the other values in the same column, and a third transformer pays attention for a given cell's row to other rows in the same table. The three transformers can be combined with a single objective to predict the empty cell, and a cell's embedding can be created by learning from all three transformers.

In some implementations, attention may include a four-dimensional attention mechanism. The four-dimension attention mechanism may be the three-dimension attention mechanism described herein with an additional attention determined from changes of the values of a cell with different versions of a table. The additional fourth attention score may correspond to attention related to changes in the version of the value of the cell with respect to time. In embodiments, the fourth attention score may be determined with an additional layer added to the model described herein.

In some implementations, attention may include a four-dimensional attention mechanism. The four-dimension attention mechanism may be the three-dimension attention mechanism described herein, with additional attention determined from determining a fourth attention score across embeddings from different tables. The additional fourth attention score may correspond to attention related to relationships of cell values in other tables. In embodiments, the fourth attention score may be determined with an additional layer added to the model described herein.

A trained large table model may be utilized in various applications. In one example, an LTM may be used to autofill values in a form or spreadsheet. Given a few or even 1 sample row, and some cell values in another row, the model may be used to generate one or more cell values in another row. The generated cell values may predict a value given not just that row, but the entire table. The generated cell value may automatically join the value with all the related data in the knowledge base captured in the neural network.

In another example, an LTM may be used for column validation. The model may be used to validate a data entry form to confirm that its values fit the column semantics and definition. The model may validate values for cells without the need for validation rules defined by users. In one example, a cell value relates to a price that may be validated by the model. A price value may be invalid if the price is outside of the range of $100-$5500. If a user enters $1.59 or $1M, it would most likely violate the column semantics. Validation rules are normally written by hand in many applications since basic data types in tables or spreadsheets do not capture such semantics without lots of code. The validation output of a model may be used to nudge the user (for example, via a user interface) to confirm if this is correct data. This mechanism can often catch data entry errors and prevent bad data from getting into the system.

In the case of a column validation, the semantic understanding and, thus the validation can be very sophisticated. In one example, a column may be categorized as “exporter” with a string in the table. The pre-trained model will inherently know (from semantics of the data learned from other tables) that it's not just an exporter but a multi-billion company in Taiwan or China that makes semiconductors and is based in a location either physically close to Taipei or a major port in China. If a new value is provided for a cell in that column that is a valid company, the pre-trained model may be configured to detect and reject the value. This sort of validation radically improves the data quality and the amount of programming required to do such validation.

In another example, an LTM may be used for correlated data validation. The model may be used to validate data entered by users in a data entry not only if the value matches the column semantics or very specific data type but also if the value matches the semantics of other columns in the same row. In one example, a value of “159.00” may be a valid price with respect to column price values but not if the product is a product that has a much higher valuation (such as an “Apple MacBook Pro”) which may be determined from semantics and value of other columns.

In another example, an LTM may be used for deep validation. The model may be used to do a complex validation that a new shipment of a product (i.e., Airpods) in a box labeled “BoxAlpha” can only carry so many articles of the product by joining with a table that includes additional information about the product such as the size, weight, etc. of the product. The model may facilitate automatic understanding of the size of the product and automatically calculating how many articles of the product can fit in the box. In another example, the model can also generate such a prediction by studying the dimensions of other items shipped in a “Grande” box and compare the relative dimensions of those objects with that of the iPod.

In another example, an LTM may be used for automatic data engineering. The method and systems described herein build a singular knowledge base (or Large Table Model) from heterogeneous tables across millions of sources, without any data engineering by utilizing the 3D attention mechanism and also be used to integrate any number of new disparate data sources. One common objective of data ingestion, transformation, and structuring is to facilitate a query of different types of data (i.e., a data lake) using a query language. Another common objective is to build a machine-learning model. Both objectives can be achieved by end users by processing more data (tables, csv, json, or compressed formats) in original form as long as it's structured. The large table model can be extended to map the new tables as if they were part of the original dataset. The fine-tuning with additional structured data doesn't discern if it was from original pre-training or user added.

Users can add random sets of customer or private data and automatically create a new revised model, which in itself has done all the data engineering, and may be automatically generated (the model may be used to transform, map, normalize, structure, and/or join and even clean bad data). The effort required is no more than just pointing the model to the storage of files. The end result would be the same, the ability to query the data as it were mapped with keys and joined at all the right places. Secondly, they can utilize the fine-tuned model itself for further machine learning by using the LTM itself or its table or row embeddings as input into any model, even as simple as logistic regression. The methods and systems described herein allow improved data engineering speed (it would be instant) vs the state of art methods which require months of intensive projects to manually understand the semantics, map data, create common structure, joins, and load all the data into that new structure.

In another example, an LTM may be used for fraud detection. Fraud in business often includes data that may look right but isn't real. For example, by studying attention between rows, the model can be used to identify all credit card transactions for a user. When a transaction is received, the model can automatically detect, using the attributes of the transaction, if the transaction is fraudulent. The model may detect if the data of the transaction doesn't fit the table or the column semantics for that row. For example, by paying attention to the other rows, it can learn that the user buys toys for kids when in San Francisco but power supplies when in Europe and does not buy running pants in New York. Such algorithms can be coded today using traditional machine learning by doing manual feature selection but the trained model described herein can identify fraud without manual coding of rules. Furthermore, in areas of procurement, the model can be used to automatically identify that a purchase order doesn't fit the bill since it knows all purchase orders, or when someone from a supplier, a US company, does not have a bank code of length 12 which is in a foreign country and that the supplier doesn't have an address in the foreign country.

In another example, an LTM may be used for query by example. By predicting or generating data values, the methods and systems described herein can also be used to create complex queries where an end user can query the underlying data store to create a new view or a new table that conforms to their needs. This new table/view may gather data from one or hundreds of underlying data tables to present its output. The query can be done natively by using Query-by-Example. For example, company=“dell”, product=?, price=?, country=“India”. This query can be expressed as an initial table which can then fill out the columns products and price and generate an output table.

In another example, an LTM may be used for query by natural language. An LLM can also be trained to take natural language and generate a structured query-by-example row which can then be utilized to generate an output table.

In another example, an LTM may be used to perform search. Users can also generate a query or a search (for example, using keywords and/or natural language). The query can be embedded using the knowledge base (i.e., the model may be used to determine an embedding of the query) and row embeddings that closely match the embeddings of the query may be identified (for example, using a similarity measure like vector cosine). This would provide a more semantic set of rows ranked by how similar the row embeddings are to the query embedding. Furthermore, the rows may be heterogeneous so querying for a Company may return all the top rows for that company across heterogeneous tables, orders, tickets, etc. providing a holistic view of that Company. Such a search may also join across tables to provide more holistic data about the search keyword(s).

In another example, an LTM may be used to generate a self-organizing data lake. In embodiments, databases may have multiple uses (like online transaction processing). The methods and systems described herein, given the ability to do data integration and mapping instantly, store and retrieve data by querying and searching, form a new basis of a new data lake (or a network). This data lake provides an advantage as it may organize any number of disparate structured data added onto it. No data engineering would be required to add data. The output structure may be self-cleaning with better quality data since it will merge with higher quality public data or identify the best information from the original LTM. The core value of data lakes are still present in the self-organizing data lake, such as the ability to semantically search and query. The new data lake provides an improved search (better than a keyword search). Also, the query, like discussed above, would provide data joining across as many underlying tables as needed.

In another example, an LTM may be used for forecasting. Given the vast amount of knowledge gained by this Large Tabular Model, which may include economic data, movement of goods, stock performance of companies, it can be used to generate forecasts (such as a prediction of future product sales). Transformer models have already proven to be useful in time-series forecasting; thus, this model with a universal understanding of tabular data in the world with millions of tables, can be utilized to predict future product sales and thus utilized for demand forecasting for supply chain and sales.

In one example, an LTM may be a transformer-based model. In one example, the output of each layer of the model is the sum of two transformers. One transformer may run attention across all the other cells in the same row (referred to herein as the RowTransformer or EntityTransformer), and a transformer that runs attention across all the other cells in the same column (referred to herein as the ColumnTransformer or AttributeTransformer).

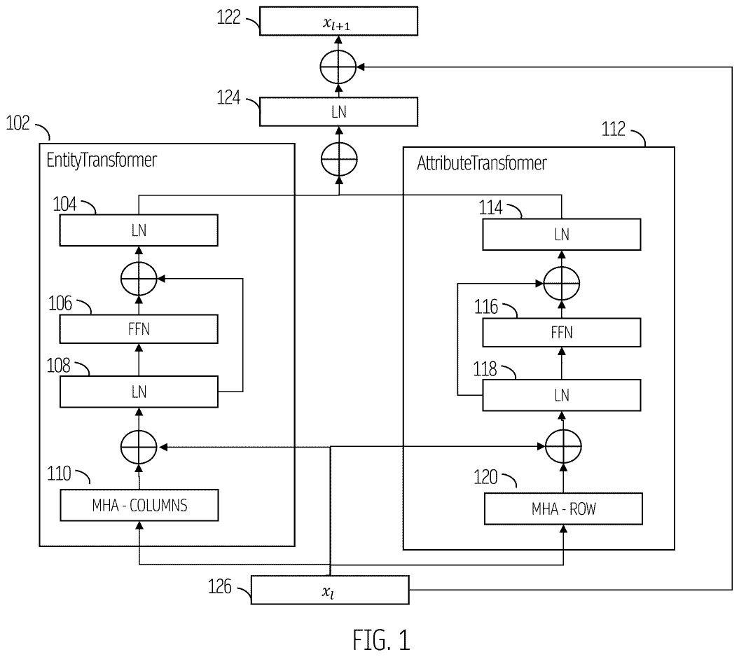

A schematic depiction of aspects of one layer of an example transformer-based model is shown in FIG. 1. The model layer includes two transformers (EntityTransformer 102 and AttributeTransformer 112). Each of the transformers includes a series of elements that include multi-head attention (MHA), feed forward network (FFN), and layer normalization (LN).

In embodiments, an input 126 to a layer may be processed in parallel by the EntityTransformer 102 and the AttributeTransformer 112. The EntityTransformer 102 may include an MHA component 110 that operates on the columns, followed by a LN component 108, FFN component 106 and another LN component 104. The AttributeTransformer 112 may include an MHA component 120 that operates on the rows, followed by an LN component 118, FFN component 116 and another LN component 114. The outputs of the EntityTransformer 102 and the AttributeTransformer 112 may be processed by another LN component 124 and used to generate the output 122 of the layer which may be an input to another layer.

The multi-head attention allows the model to focus on different parts of the input sequence simultaneously, capturing dependencies between row elements and/or column elements. This is achieved by computing attention scores using query, key, and value matrices, followed by a scaling and softmax operation to obtain the attention weights. By using multiple heads, the model can learn different aspects of the sequence in parallel, enhancing its ability to understand complex patterns. The feed-forward network provides a mechanism to transform the data non-linearly. Positions in the input sequence are processed by the FFN. The FFN allows the model to apply complex transformations and capture non-linear relationships within the data. The LN normalizes the input across the features dimension, maintaining consistent behavior and preventing issues like vanishing or exploding gradients. This combination of MHA, FFN, and LN within each Transformer layer enables the model to handle long-range dependencies and complex structures in the data.

The architecture of the example model is further described in algorithms 1, 2, 3, and 4. It should be noted that while operations of the algorithms are defined elementwise for clarity, it is to be understood that operations may include tensor operations.

Algorithm 1 shows operations included in a RowTransformer (also referred to as an EntityTransformer herein) operation of FIG. 1. For each attention head h, the RowTransformer computes q, k and v using the Linear operation on the rows of an input table. In one example, q, k, and v may correspond to query, key, and value projections respectively. For each attention head, an output o is computed using softmax operation based on the q, k, and v outputs. In embodiments, a RowTransformer may include any number of heads such as, for example, 8, 16, or more. The output of the RowTransformer is computed using the outputs o for each head using the LayerNorm (also referred to as LN or layer normalization) operations.

Algorithm 1 Row Transformer

H ← number of attention heads
function RowTRANSFORMER(\hat{X}, row number r, column number c)
for h ← 1..H do

| | |
|---|---|
| q^{h} ← Linear(\hat{X}_{r,c}) | [symbol] q^{h} ∈ [symbol] , \hat{X}_{r,c} ∈ [symbol] |
| ${k}_{j}^{h} ← Linear ( {\hat{X}}_{r , j} ) for all column numbers j$ | [symbol] kⱼ^{h} ∈ [symbol] |
| ${v}_{j}^{h} ← Linear ( {\hat{X}}_{r , j} ) for all column numbers j$ | [symbol] vⱼ^{h} ∈ [symbol] |
| ${o}^{h} ← {\sum }_{j} {softmax}_{j} ( \frac{{q}^{hT} {k}_{j}^{h}}{\sqrt{D}} ) {v}_{j}^{h}$ | [symbol] o^{h} ∈ [symbol] |
| end for | |
| $o ← LayerNorm ( {\hat{X}}_{r , c} + \frac{1}{H} {\sum }_{h} {o}_{h} )$ | |
| return ← LayerNorm (o + Linear (Relu (Linear (o)))) | |
| end function | |

Algorithm 2 shows operations included in a ColumnTransformer (also referred to as an AttributeTransformer herein) operation of FIG. 1. For each attention head h, the ColumnTransformer computes q, k and v using the Linear operation on the columns of an input table. For each attention head, an output o is computed using softmax operation based on the q, k, and v outputs. In embodiments, a ColumnTransformer may include any number of heads such as, for example, 8, 16, or more. The output of the ColumnTransformer is computed using the outputs o for each head using the LayerNorm (also referred to as LN or layer normalization) operations.

| Algorithm 2 Column Transformer | |
|---|---|
| H ← number of attention heads | |
| function COLUMNTRANSFORMER(\hat{X}, row number r, column mumber c) | |
| for h ← 1..H do | |
| q^{h} ← Linear(\hat{X}_{r,c}) | [symbol] q^{h} ∈ [symbol] , \hat{X}_{r,c} ∈ [symbol] |
| ${k}_{i}^{h} ← Linear ( {\hat{X}}_{i , c} ) for all row numbers i$ | [symbol] kᵢ^{h} ∈ [symbol] |
| ${v}_{i}^{h} ← Linear ( {\hat{X}}_{i , c} ) for all row numbers i$ | [symbol] vᵢ^{h} ∈ [symbol] |
| ${o}^{h} ← {\sum }_{i} {softmax}_{i} ( \frac{{q}^{hT} {k}_{i}^{h}}{\sqrt{D}} ) {v}_{i}^{h}$ | [symbol] o^{h} ∈ [symbol] |
| end for | |
| $o ← LayerNorm ( {\hat{X}}_{r , c} + \frac{1}{H} {\sum }_{h} {o}_{h} )$ | |
| return LayerNorm (o + Linear (Relu (Linear (o)))) | |
| end function | |

Algorithm 3 shows operations included in a layer of the model. Algorithm 3 shows operations included for combining outputs of ColumnTransformer and RowTransformer as shown in FIG. 1.

Algorithm 3 TableTransformer

```
function TABLETRANSFORMER(\hat{X}, row number r, column number c)
  o ← ColumnTransformer(\hat{X}, r, c) + RowTransformer(\hat{X}, r, c)
  return LayerNorm(o)
end function
```

Algorithm 4 shows operations for a model. The operations include multiple layers of transformers. The TableTranformerModel iterates for a plurality of rows and columns of a table. The rows and columns are processed using one or more layers of the transformer structure depicted in FIG. 1. The output of the model is a decoded table value(s) using a decoder operation (LLM-Decoder). In one example, the LLM-Decoder may map embeddings to values for applications described herein.

```
Algorithm 4 Table TransformerModel
L ← number of layers
function TABLETRANSFORMERMODEL(\hat{X})
-\hat{X}⁽⁰⁾ ← \hat{X}
  for l ← 1..L do
    for r ← 1..number of rows do
      for c ← 1..number of columns do
        ${\hat{X}}_{r , c}^{( l )} ← {\hat{X}}_{r , c}^{( l - 1 )} + TableTransformer ( {\hat{X}}^{( l - 1 )} , r , c )$
      end for
    end for
  end for
  return LLM-Decoder (\hat{X}^{L})
end function
```

In embodiments, the LTM models (such as the model described with respect to Algorithm 4) may be trained with tabular data. In embodiments, training data may include any type of tabular data. In some cases, training data may include tabular data that includes large tables (one million or more rows and/or columns). In cases where the tables are too large to process as one input to a model, a sampling strategy may be used.

Training using large table data may include random sampling of row data. In one example, for each training sample, a table \hat{X}^{p} is randomly selected. From the selected table, a sub-table may be created by randomly selecting S rows. In the sample of S rows, one or more cells may be masked. Cells may be masked at a rate of β. Both S and β are tune-able hyperparameters. In one example S∈[1k, 10k] and β∈[0.05, 0.2].

An LTM model (such as the TableTransformerModel of Algorithm 4) is iteratively trained on masked data. At the start of each iteration, a batch of masked data is fed into the transformer model. The model performs a forward pass, generating predictions for the masked data cells. The discrepancy between these predictions and the actual masked tokens is quantified by computing a loss value (i.e., cross-entropy loss). The loss is then used in backpropagation to calculate gradients, which guide the optimization algorithm, in updating the model's parameters to minimize the loss. This cycle of forward pass, loss calculation, backpropagation, and parameter update repeats for a predefined number of epochs or until a convergence criterion is met. Periodically, the model's performance is evaluated on a validation set to monitor progress and prevent overfitting.

In some embodiments, the loss may be computed on the LLM-Decoder output of the LTM. In some embodiments, the LTM may be trained on outputs \hat{X}^{L} without querying LLMDecoder, in which case the loss function may be the loss between

$${\hat{X}}_{ij}^{L}$$

and \hat{X}ᵢⱼ for masked cells. A model trained without the LLM-Decoder output may be later fine-tuned with the LLM-Decoder using a smaller set of training data.

In embodiments, training includes training and validation/testing. Training data may be split into a training data set and a testing data set. The training data set is used to train the model and the test set provides an evaluation of the model's performance. In one example, data may be randomly split between the training and testing data sets. In one example, splitting of data may include randomly assigning rows to one dataset or the other. In another example, the splitting of data may include randomly assigning tables. Splitting on rows may lead to better model performance for some data. Splitting on tables may lead to a more generalizable model that provides good performance for different types of data.

In embodiments, training data may be padded with extra columns, rows, and/or cells so that each training and/or testing sample has the same number of columns of the largest table in the dataset. The padded values may be masked during the attention calculation of the RowTransformer during training.

In embodiments, various approaches may be used for masking of data values/cells during training. In one approach, masked cells may be identically and independently distributed in the training data. In this example, a cell may be provided as an input unmasked in one training example, but it may be the masked output in another example. In another approach, masking may include permanently masking the p fraction of cells. In this approach, during training, a cell is designed to be either masked or unmasked for all training samples.

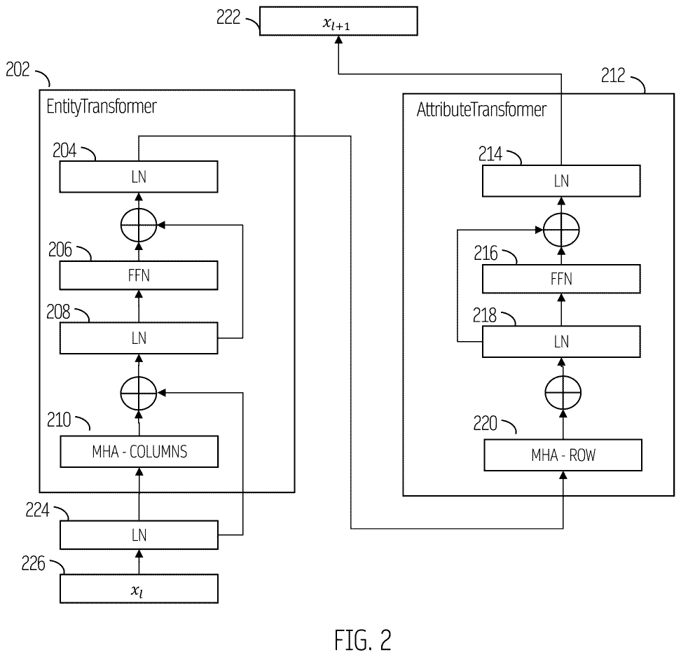

A schematic depiction of aspects of one layer of another example transformer-based model is shown in FIG. 2. In this example, the transformers are arranged in series. The model layer includes two transformers (EntityTransformer 202 and AttributeTransformer 212). Each of the transformers includes a series of elements that include MHA, FFN, and LN.

In embodiments, an input 226 to a layer may be processed first by the EntityTransformer 202. The EntityTransformer 102 may include an MHA component 210 that operates on the columns, followed by a LN component 208, FFN component 206 and another LN component 204. The output of the EntityTranformer 202 may be the input to the AttributeTransformer 212. AttributeTransformer 212 may include an MHA component 220 that operates on the rows, followed by a LN component 218, FFN component 216 and another LN component 214. The outputs of the AttributeTransformer 212 may be the output 222 of the layer which may be an input to another layer.

Algorithms 5-8 describe another example of a transformer-based LTM (CollabFilteringTransformerModel). The example LTM described in algorithms 5-8 takes advantage of the structured data already accessible in the relational data tables and provides a mechanism to look up information from other rows and other tables in order to predict the value of a given cell. This way, the information needed does not have to be stored in the model parameters because the model can always look up the information in the tables themselves.

The LTM model includes collaborative filtering. Collaborative filtering is based on the assumption that any row in a table may be a weighted average of every other row in the table, where the weight is determined by similarity (for example, a reaction to a new streaming movie recommendation may be made by scoring the similarity of interests to all other users and predict the average recommendation from the most similar users).

The LTM uses an attention mechanism that can span multiple tables with different columns to find the most similar rows, and then uses these similar rows to predict a value of a cell. The CollabFilteringTransformerModel, includes an extra layer before the final output. This layer is an attention mechanism that allows a row to identify similar rows and then builds a weighted average of these rows' vectors to predict the cell's value. Let the current cell being predicted be in the r-th row and the -th column. The vectors produced in this layer are:
kᵢ—A key vector for each row in the sampled sub-matrix
vᵢ—A value vector for each row in the sampled sub-matrix
qᵣ—A query vector for the current cell's row
y_{c}—A vector for the current cell's column

The relevance of rowᵢ to the current rowᵣ is equal to:

$${a}_{i} = {softmax}_{i ; i \neq r} ( \frac{{k}_{i}^{T} {q}_{r}}{\sqrt{D}} )$$

The resulting weighted average vector representing the given row is given by

$${w}_{r} = {\sum }_{i ; i \neq r} {a}_{i} \cdot {v}_{i}$$

and the final prediction vector for the cell is strictly a function of the vectors wᵣ and y_{c}. The current row is only used to generate the query vector; otherwise, the prediction is only a function of other rows, which forces the model to rely on the “looked-up” information it finds in other rows instead of memorizing the relationship between the cells in the row.

Algorithm 5 shows operations included in a RowEncoder. For each column, the RowEncoder computes w and v LinearScalar and Linear operation, respectively. For each row, an output o is computed using softmax o

Algorithm 5 RowEncoder

| | |
|---|---|
| function ROWENCODER(\hat{X}, row number r) | |
| for j ← 1..number of columns do | |
| wⱼ ← LinearScalar(\hat{X}_{r,j}) | [symbol] LinearScalar : [symbol] → [symbol] |
| vⱼ ← Linear(\hat{X}_{r,j}) | [symbol] vⱼ ∈ [symbol] |
| end for | [symbol] o ∈ [symbol] |
| o ← Σⱼ softmaxⱼ (wⱼ) vⱼ | |
| return Linear (Relu (Linear (Layer Norm (o)))) | |
| end function | |

peration based on the w and v outputs.

Algorithm 6 shows operations included in a ColumnEncoder. For each row, the ColumnEncoder computes w and v LinearScalar and Linear operation respectively. For each column, an output o is computed using softmax operation based on the w and v outputs.

Algorithm 6 ColumnEncoder

| | |
|---|---|
| function COLUMNENCODER(\hat{X}, column number c) | |
| for i ← 1..number of rows do | |
| wⱼ ← LinearScalar(\hat{X}_{i,c}) | [symbol] LinearScalar : [symbol] → [symbol] |
| vⱼ ← Linear(\hat{X}_{i,c}) | [symbol] vⱼ ∈ [symbol] |
| end for | [symbol] o ∈ [symbol] |
| o ← Σⱼ softmaxⱼ (wⱼ) vⱼ | |
| return Linear (Relu (Linear (Layer Norm (o)))) | |
| end function | |

Algorithm 7 shows operations included in a CollabFilteringTransformer. CollabFilteringTransformer operation uses the RowEncoder and ColumnEncoder operations to compute and final output o.

Algorithm 7 CollabFiltering Transformer

| function COLLABFILTERING TRANSFORMER(\hat{X}, row number r, column number c) | |
|---|---|
| qᵣ ← RowEncoder(\hat{X}, r) | [symbol] qᵣ ∈ [symbol] |
| y_{c} ← ColumnEncoder(\hat{X}, c) | [symbol] y_{c} ∈ [symbol] |
| for i ← 1.. number of rows do | |
| vᵢ ← Linear(\hat{X}_{i,c}) | [symbol] vᵢ ∈ [symbol] |
| kᵢ ← Linear(\hat{X}_{i,c}) | [symbol] kᵢ ∈ [symbol] |
| end for | |
| ${w}_{r} ← LayerNorm ( {\sum }_{i} {softmax}_{i} ( \frac{{q}_{r}^{T} {k}_{i}}{\sqrt{D}} ) {v}_{i} )$ | [symbol] wᵣ ∈ [symbol] |
| o_{concat} ← concatenate(wᵣ, y_{c}) | [symbol] o_{concat} ∈ [symbol] |
| o_{final} ← LayerNorm (Linear (Relu (Linear (o_{concat})))) | [symbol] o_{final} ∈ [symbol] |
| return o_{final} | |
| end function | |

Algorithm 8 shows operations included in a CollabFilteringTransformerModel. The operations include multiple layers of transformers and includes both the TableTransfromer and CollabFilteringTransformer. The output of the model is a decoded table value(s) using a decoder operation (LLM-Decoder). Additionally, CollabFilteringTransformerModel has the same parameters as TableTransformerModel except for the last layer and its training can be warm started from the parameters trained in TableTransformerModel. The parameters kᵢ, vᵢ, and y_{c} can all be generated independently of each other so that once the model has been trained, the vectors can be generated for every row and every column across all tables once and then stored. Every time an application needs to run a form field auto complete or feed relevant information into an LLM, it only has to generate a q, vector and make additional simple computations that include dot products and averages against already calculated vectors. This makes all data stored in all of the relational databases semantically searchable.

Algorithm 8 CollabFiltering Transformer Model

```
L ← number of layers
function COLLABFILTERING TRANSFORMER MODEL(\hat{X})
-\hat{X}⁽⁰⁾ ← \hat{X}
  for l ← 1..L do
    for r ← 1..number of rows do
      for c ← 1..number of columns do
        ${\hat{X}}_{r , c}^{( l )} ← TableTransformer ( {\hat{X}}^{( l - 1 )} , r , c )$
      end for
    end for
  end for
  for r ← 1..number of rows do
    for c ← 1..number of columns do
      ${\hat{X}}_{r , c}^{L + 1} ← CollabFilteringTransformer ( {\hat{X}}^{L} , r , c )$
    end for
  end for
  return LLM-Decoder(\hat{X}^{L+1})
end function
```

Training of CollabFilteringTransformerModel includes two phases. The first phase is identical to the training process of TableTranformerModel. Each training example is generated by randomly selecting one of the data tables and then randomly sampling a subset of rows, with all of the same considerations around masking that are described herein. Once the phase 1 training is complete, we can use the trained CollabFilteringTransformerModel model to generate the column and row vectors kᵢ, vᵢ, and y_{c} (i.e. the key vector and query vector for each row and the column vector for each column) for all columns and rows across all data tables.

For phase 2 of the training, training examples are constructed such that they span multiple tables and teach the model how to find information across different tables. In one example, the steps for generating a training example in phase 2 training include:
1. Randomly select a row r from a randomly sampled data table, where its query vector is qᵣ.
2. Identifying the top S rows across all tables that maximize

$${k}_{i}^{T}$$

qᵣ. These top S rows are relevant to row r across all tables.
3. Feed the resulting sub-table into CollabFilteringTransformerModel and have it predict the masked cells in row r.

During phase 2 training, kᵢ, vᵢ, and y_{c} and the parameters that are used to calculate their values are kept constant. In phase 2 training, parameters that are being updated include parameters that are used to produce the row value vector vᵢ, and the parameters used to combine and process the concatenated row and column vector in CollabFilteringTransformer.

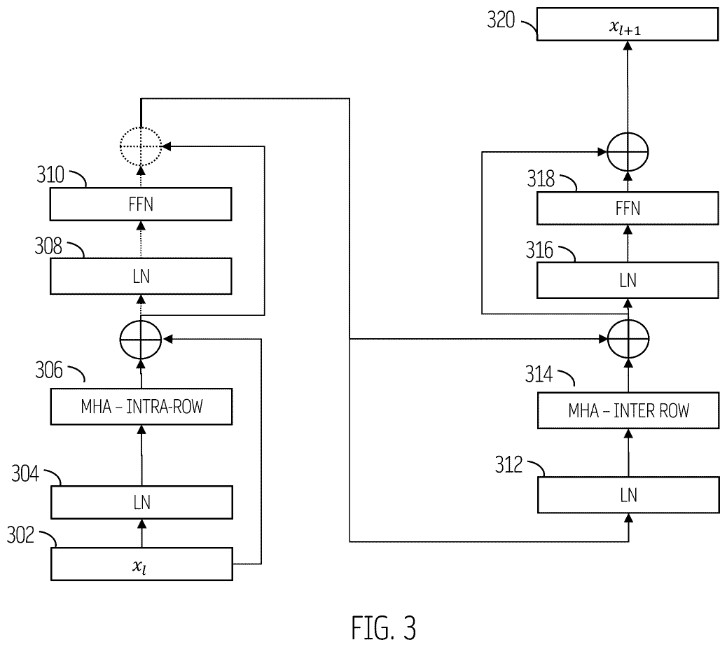

A schematic depiction of aspects of one layer of another example transformer-based model is shown in FIG. 3. The model layer includes two multi-head attention elements that compute intra row and inter attention scores. In embodiments, an input 302 to a layer may be processed first by LN component 304 for followed by an MHA component 306 that computes intra row attention score. The output of MHA 306 is processed by an LN component 308 and FFN component 310. The layer may further process data with another LN component 312 followed by an MHA component 314 that computer inter-row attentions score. The output of the MHA 314 may be processed by an LN component 316 and a FFN component 318 to generate output 320.

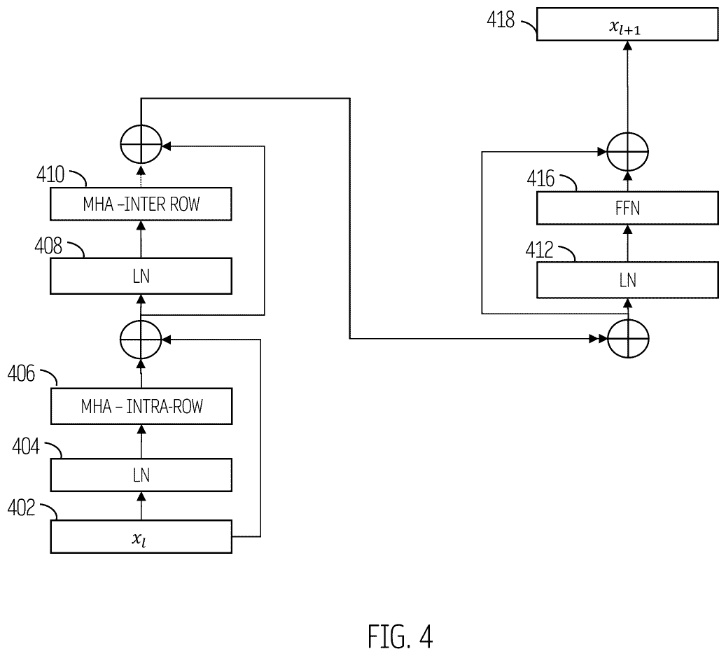

A schematic depiction of aspects of one layer of another example transformer-based model is shown in FIG. 4. The model layer includes two multi-head attention elements that compute intra row and inter attention scores. In embodiments, an input 402 to a layer may be processed first by LN component 404 for followed by an MHA component 406 that computes intra row attention score. The output of MHA 406 is processed by an LN component 408 and another MHA component 410 that computes inter-row attentions scores. The layer may further process data with another LN component 412 followed by an FFA component 416 to generate output 418.

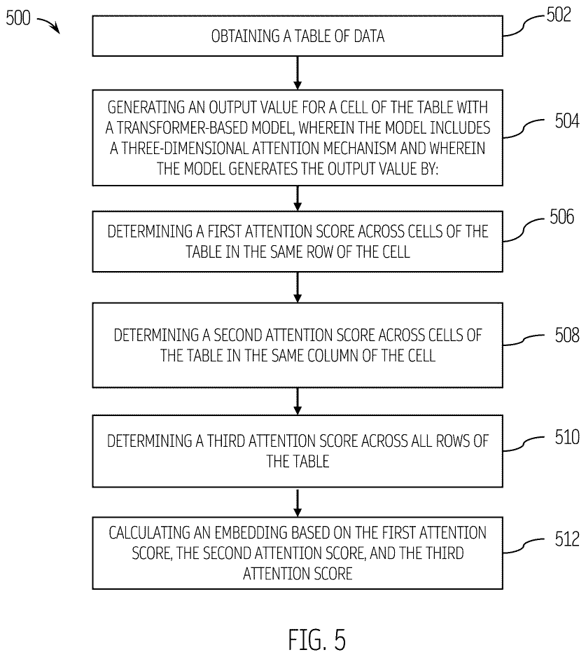

A flow diagram of an example method 500 for processing tabular data with an LTM is depicted in FIG. 5. The LTM may process tabular data with a plurality of layers. The layers may include transformers that calculate attention scores in tabular data. The method may include a step 502 of obtaining tabular data. The tabular data may include a plurality of cells arranged in rows and columns. The method may further include a step 504 of generating an output value for a cell of the table with a transformer-based model. In embodiments the model may include a multi-dimensional attention mechanism and may include one or more layers. In one example, the model includes a three-dimensional attention mechanism. The method may include the step 506 of determining a first attention score across cells of the table in the same row of the cell, the step 508 of determining a second attention score across cells of the table in the same column of the cell, and the step 510 of determining a third attention score across all rows of the table. The method may further include the step 512 of calculating an embedding based on the first attention score, the second attention score, and the third attention score and determining the output value based on the embedding.

In embodiments, an attention score may be calculated by taking the dot product of the query vector of a token with the key vectors of other tokens. The score may be then scaled by dividing by the square root of the dimensionality of the key vectors to ensure stable gradients. The resulting scores are passed through a softmax function to obtain attention weights. These weights are then used to compute a weighted sum of the value vectors, producing a new representation for each token that integrates information from the entire sequence. In one example, attention weights may be computed using the formula for aᵢ described herein. In embodiments, layers of the model may include additional elements as described with respect to FIGS. 1-4 and Algorithms 1-8.

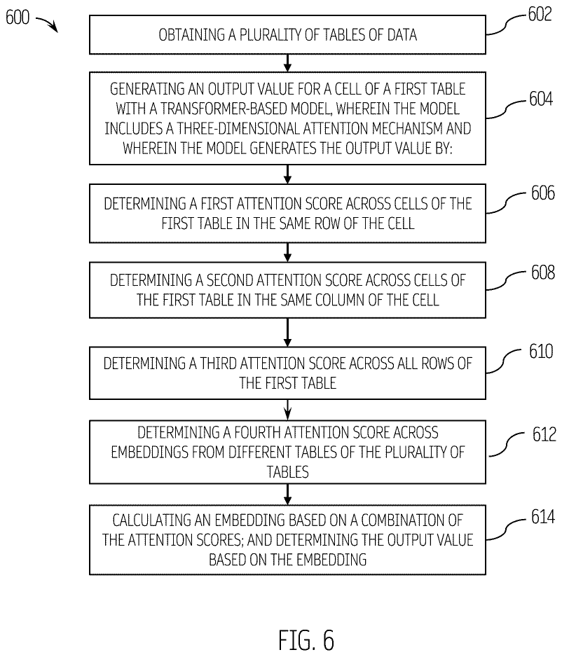

A flow diagram of another example method 600 for processing tabular data with an LTM is depicted in FIG. 6. The LTM may process tabular data with a plurality of layers. The layers may include transformers that calculate attention scores in tabular data. The method may include a step 602 of obtaining a plurality of tables of data. The tables may include a plurality of cells arranged in rows and columns. The method may further include a step 604 of generating an output value for a cell of the table with a transformer-based model. In embodiments, the model may include a multi-dimensional attention mechanism and one or more layers. In one example, the model includes a four-dimensional attention mechanism. The method may include the step 606 of determining a first attention score across cells of a first table in the same row of the cell, the step 608 of determining a second attention score across cells of the first table in the same column of the cell, and the step 610 of determining a third attention score across all rows of the first table. The method may further include the step 612 of determining a fourth attention score across embeddings from different tables of the plurality of tables.

The method may further include the step 614 of calculating an embedding based on the attention scores (e.g., the first attention score, the second attention score, the third attentions score, and the fourth attention score) and determining the output value based on the embedding.

Those skilled in the art will appreciate that the methods and systems described herein provide for a number of benefits. In one aspect, usage of a large pre-trained neural network (i.e. Large Table Model) trained over large amounts of structured data (such as tabular data) may be applied to a new table or spreadsheet to generate or predict data values by processing one or a few samples from the new table. In another aspect, by paying attention to the rows in the table, the model learns and embeds the meaning or semantics to what it means to be a value in a table that is different than being in another table. In another aspect, the structure of the model allows the model to automatically learn how to join itself with other rows that are related in all the training data that its fed. Conventional models in machine learning or even LLM's do not learn how to join disparate tables.

In another aspect known machine learning models used for tabular data deal with only one table at a time; thus, very limited to the scale at which they can be trained. Conventional machine learning over structured data can be visualized as a table with features but all features are about the singular class being trained. The previous methods cannot handle data that is completely heterogeneous with related or unrelated tables. This means that previous methods require manual effort, such as a data engineer to prepare and manually join all the right features to learn a class. The methods and systems described herein make machine learning over tabular data very scalable. The models described herein can be trained on any type or number of tables since each table row is an input along with its column and the embedding representing all the rows in that table. The triple: the row itself, the column, and the universal row of that table; can be fed into a single model. The model is very flexible where any number or amount of related or unrelated tables can be used to train the model and the model learns how these rows, tables, and columns are related. Each cell embedding learns and embeds its knowledge of the universe of related data without any human intervention. No intensive data prep or knowledge worker who understands the data is required.

The methods and systems described herein enable a new way of doing machine learning, prediction, or classification over structured data. Current state-of-the-art approaches like Random Forest or XGBoost only utilize the data in the row itself. The models described herein utilize the row, which themselves have a deeper understanding of the entire column, the entire table, related tables, and tables related to those tables recursively.

The 3-dimensional attention mechanism described herein for creating the embedding for each cell value also short circuits the manual and very data-intensive part of machine learning over structured data which is feature selection. The embedding created by this 3-dimensional attention mechanism also automatically understands how table values are related to the entire world and may pick predictive features or columns. In one example, the value of “159” includes the value and an understanding that the value is a price of a product (e.g., a product in an Apple product table), and thus if the model is asked to predict the price, if masked, it would automatically know that it's most similar to other products (e.g. headphones, tablets) and predict the value accurately. In another example, let's imagine that all prices for all of a company's products are hidden from this model. The model may still learn aspects related to the value, other values in the table, or other tables. Aspects may be learned from values relating to the taxes calculated for a row, from the values of how much it costs from the order table, from values of how much was the price from the returns table, or from values that indicate how much it takes to manufacture such a device from the bill of materials table. In another example, if the price and order table or returns or bill of materials didn't exist, the model may learn from a table of product reviews that it found in the same column. The model may identify the price of the competitor product and may predict the price from the competitor price using knowledge that Apple products are priced on the high end of competitive products.

Given that the original pre-trained model is trained on related and unrelated facts to all business objects, it is also open to being fine-tuned on customer private data. The pre-trained model can be fine-tuned on any amount of private data to learn about new related facts and relationships. Fine-tuning can be performed without data engineering or manual joins or much human labor since the original dataset was already a vast array of related and unrelated data. This opens the model to be fine-tuned further by customers very easily by just providing it with more structured data about facts that it may not know or concepts only used within that customer or industry. No code, joins, or translation must be done to have the model learn new related data.

The methods and systems described herein generate more accurate data than the original training data. For example, if a company's revenue column value is consistently underreported across every single mention of that company, the generated value will autocorrect itself based on the entirety of knowledge known to it. The model may make a prediction based on all the information about other columns in the company dataset and also all related tables, including website visits, products sold, reviews, all related tables, etc. The prediction may also be based on how that company fits in with other companies in that table, how it fits with related tables and other rows in those related tables.

The models described herein can be applied back to the original data it was trained on and can be used to fix mistakes in the original data. In embodiments, a model may self-improve itself by iteratively correcting data and retraining on the data. For example, if we systematically distort every single instance of revenue of a company to $1 in all of its training data to a point it has no knowledge of the company's correct revenue, the model will autocorrect and generate the revenue back to an actual value (e.g. $100B).

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems disclosed herein. The terms computer, computing device, processor, circuit, and/or server, as utilized herein, should be understood broadly.

Any one or more of the terms computer, computing device, processor, circuit, and/or server include a computer of any type, capable to access instructions stored in communication thereto such as upon a non-transient computer readable medium, whereupon the computer performs operations of systems or methods described herein upon executing the instructions. In certain embodiments, such instructions themselves comprise a computer, computing device, processor, circuit, and/or server. Additionally or alternatively, a computer, computing device, processor, circuit, and/or server may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware, computers, computing devices, processors, circuits, and/or servers include, without limitation, a general purpose computer, a server, an embedded computer, a mobile device, a virtual machine, and/or an emulated version of one or more of these. Example and non-limiting hardware, computers, computing devices, processors, circuits, and/or servers may be physical, logical, or virtual. A computer, computing device, processor, circuit, and/or server may be: a distributed resource included as an aspect of several devices; and/or included as an interoperable set of resources to perform described functions of the computer, computing device, processor, circuit, and/or server, such that the distributed resources function together to perform the operations of the computer, computing device, processor, circuit, and/or server. In certain embodiments, each computer, computing device, processor, circuit, and/or server may be on separate hardware, and/or one or more hardware devices may include aspects of more than one computer, computing device, processor, circuit, and/or server, for example as separately executable instructions stored on the hardware device, and/or as logically partitioned aspects of a set of executable instructions, with some aspects of the hardware device comprising a part of a first computer, computing device, processor, circuit, and/or server, and some aspects of the hardware device comprising a part of a second computer, computing device, processor, circuit, and/or server.

A computer, computing device, processor, circuit, and/or server may be part of a server, client, network infrastructure, mobile computing platform, stationary computing platform, or other computing platform. A processor may be any kind of computational or processing device capable of executing program instructions, codes, binary instructions, and the like. The processor may be or include a signal processor, digital processor, embedded processor, microprocessor, or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions, and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server, and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client, and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices utilized for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM, and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players, and the like. These mobile devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information. Operations including interpreting, receiving, and/or determining any value parameter, input, data, and/or other information include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first operation to interpret, receive, and/or determine a data value may be performed, and when communications are restored an updated operation to interpret, receive, and/or determine the data value may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g. where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The elements described and depicted herein, including in flow charts, block diagrams, and/or operational descriptions, depict and/or describe specific example arrangements of elements for purposes of illustration. However, the depicted and/or described elements, the functions thereof, and/or arrangements of these, may be implemented on machines, such as through computer executable transitory and/or non-transitory media having a processor capable of executing program instructions stored thereon, and/or as logical circuits or hardware arrangements. Example arrangements of programming instructions include at least: monolithic structure of instructions; standalone modules of instructions for elements or portions thereof, and/or as modules of instructions that employ external routines, code, services, and so forth; and/or any combination of these, and all such implementations are contemplated to be within the scope of embodiments of the present disclosure Examples of such machines include, without limitation, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements described and/or depicted herein, and/or any other logical components, may be implemented on a machine capable of executing program instructions. Thus, while the foregoing flow charts, block diagrams, and/or operational descriptions set forth functional aspects of the disclosed systems, any arrangement of program instructions implementing these functional aspects are contemplated herein. Similarly, it will be appreciated that the various steps identified and described above may be varied, and that the order of steps may be adapted to particular applications of the techniques disclosed herein. Additionally, any steps or operations may be divided and/or combined in any manner providing similar functionality to the described operations. All such variations and modifications are contemplated in the present disclosure. The methods and/or processes described above, and steps thereof, may be implemented in hardware, program code, instructions, and/or programs or any combination of hardware and methods, program code, instructions, and/or programs suitable for a particular application. Example hardware includes a dedicated computing device or specific computing device, a particular aspect or component of a specific computing device, and/or an arrangement of hardware components and/or logical circuits to perform one or more of the operations of a method and/or system. The processes may be implemented in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer-readable instructions described above. All such permutations and combinations are contemplated in embodiments of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

What is claimed is:

1. A computer-implemented method, comprising:
obtaining, by one or more processors, tabular data comprising a plurality of cells arranged in rows and columns;
obtaining temporal information associated with the tabular data, wherein the temporal information indicates changes in at least a portion of the tabular data over time; and
generating, by the one or more processors using a transformer-based model, an output for a target cell based on an embedding for the target cell, wherein generating the output comprises:
determining a first attention score based on cells in a same row as the target cell;
determining a second attention score based on cells in a same column as the target cell;
determining a third attention score based on rows of the tabular data;
determining a fourth attention score based on the temporal information, wherein the fourth attention score represents attention across time with respect to the target cell;
calculating the embedding for the target cell based on a combination of the first attention score, the second attention score, the third attention score, and the fourth attention score; and
determining the output for the target cell based on the embedding.

2. The method of claim 1, wherein the output comprises a predicted value for the target cell.

3. The method of claim 1, wherein the output comprises a validation result indicating whether a value in the target cell satisfies a learned column semantic.

4. The method of claim 1, wherein obtaining the temporal information comprises obtaining a sequence of versions of the tabular data, each version associated with a respective timestamp.

5. The method of claim 4, wherein determining the fourth attention score comprises applying attention across embeddings corresponding to the target cell in at least two different versions of the tabular data.

6. The method of claim 1, wherein the transformer-based model is trained using masked-cell prediction in which a subset of cells is masked and a loss is computed based on predicted values for the masked cells.

7. The method of claim 1, wherein the transformer-based model comprises a plurality of layers, and wherein at least two of the first attention score, the second attention score, the third attention score, and the fourth attention score are computed in different respective layers of the plurality of layers.

8. The method of claim 1, wherein the transformer-based model is at least one of a pre-trained model or a fine-tuned model.

9. The method of claim 1, wherein the temporal information indicates changes in values of the target cell over time.

10. The method of claim 1, wherein the temporal information indicates changes in values of a set of cells that includes the target cell over time.

11. One or more non-transitory computer-readable media storing instructions that, when executed by one or more processors, cause the one or more processors to perform operations comprising:
obtaining tabular data comprising a plurality of cells arranged in rows and columns;
obtaining temporal information associated with the tabular data, wherein the temporal information indicates changes in at least a portion of the tabular data over time; and
generating, using a transformer-based model, an output for a target cell based on an embedding for the target cell, wherein generating the output comprises:
determining a first attention score based on cells in a same row as the target cell;
determining a second attention score based on cells in a same column as the target cell;
determining a third attention score based on rows of the tabular data;
determining a fourth attention score based on the temporal information, wherein the fourth attention score represents attention across time with respect to the target cell;
calculating the embedding for the target cell based on a combination of the first attention score, the second attention score, the third attention score, and the fourth attention score; and
determining the output for the target cell based on the embedding.

12. The one or more non-transitory computer-readable media of claim 11, wherein the output comprises a predicted value for the target cell.

13. The one or more non-transitory computer-readable media of claim 11, wherein the output comprises a validation result indicating whether a value in the target cell satisfies a learned column semantic.

14. The one or more non-transitory computer-readable media of claim 11, wherein obtaining the temporal information comprises obtaining a sequence of versions of the tabular data, each version associated with a respective timestamp.

15. The one or more non-transitory computer-readable media of claim 14, wherein determining the fourth attention score comprises applying attention across embeddings corresponding to the target cell in at least two different versions of the tabular data.

16. The one or more non-transitory computer-readable media of claim 11, wherein the transformer-based model is trained using masked-cell prediction in which a subset of cells is masked and a loss is computed based on predicted values for the masked cells.

17. The one or more non-transitory computer-readable media of claim 11, wherein the transformer-based model comprises a plurality of layers, and wherein at least two of the first attention score, the second attention score, the third attention score, and the fourth attention score are computed in different respective layers of the plurality of layers.

18. The one or more non-transitory computer-readable media of claim 11, wherein the transformer-based model is at least one of a pre-trained model or a fine-tuned model.

19. The one or more non-transitory computer-readable media of claim 11, wherein the temporal information indicates changes in values of the target cell over time.

20. The one or more non-transitory computer-readable media of claim 11, wherein the temporal information indicates changes in values of a set of cells that includes the target cell over time.
